(19) United States
(12) Patent Application Publication
(10) Pub. No.: US 2009/0084221 A1
(43) Pub. Date: Apr. 2, 2009

(54) BRAKE LEVER AND POSITIONING DEVICE FOR THE SAME

(76) Inventors: Wen-Tsung LIU, Changhua City (TW); Jing-Ling DUNG, Changhua City (TW)

Correspondence Address: Muncy, Geissler, Olds & Lowe, PLLC, P.O. BOX 1364, FAIRFAX, VA, 22038-1364, US

(21) Appl. No.: 12/239,143

(22) Filed: Sep. 26, 2008

(30) Foreign Application Priority Data
Sep. 28, 2007 (TW) 96216246

(51) Int. Cl. B62K 23/06

(52) U.S. Cl. 74/502.2

(57) ABSTRACT

A positioning device for a brake lever includes a first stationary member, a second stationary member and two positioning members. The first stationary member is connected to a lever bracket while the second stationary member corresponds to the first stationary member and is adapted to mount on a handlebar. The two positioning members are respectively mounted on the stationary members and can be engaged with each other to position the brake lever relative to the handlebar.

### RELATED APPLICATIONS

This application claims priority to Taiwan Application Serial Number 96216246, filed Sep. 28, 2007, which is herein incorporated by reference.

### FIELD OF THE INVENTION

The present invention relates to a brake lever, and more particularly to a brake lever having a positioning function.

### BACKGROUND OF THE INVENTION

A brake lever is mounted on a handlebar and is connected to a brake cable, wherein braking of a transportation vehicle is operated to provide a brake function by pulling the brake cable through the brake lever. The brake lever is typically applied on the transportation vehicle, such as a bicycle, a motorcycle and the likes.

The existing brake lever is set with a lever connection portion, and the brake lever is assembled on the handlebar by fastening the lever connection portion onto the handlebar via a fixing element, such as a bolt. However, the brake lever is subject to strike or hit by external force so as to rotate relative to the handlebar. Therefore, to adjust the relative position between the brake lever and the handlebar, a tool is needed to loose the locking element, next the relative position between the brake lever and the handlebar is adjusted, and then the fixing element is refastened. Accordingly, the adjusting and the using of the brake lever are inconvenient.

In addition, when the bike leaves the factory, in the concern of the packing space, the brake lever is typically rotated relative to the handlebar to a position that the whole bike occupies the smallest space for the benefits of storing and conveying. After the package is opened to assemble the bike, a tool is also needed to loose the fixing element, next the relative position between the brake lever and the handlebar is adjusted, and then the fixing element is refastened. Therefore, the adjusting and the using of the brake lever are inconvenient.

### SUMMARY OF THE INVENTION

One objective of the present invention is to provide a brake lever, wherein the brake lever includes a positioning device, so that the relative position between the brake lever and a handlebar can be adjusted and fixed rapidly.

Another objective of the present invention is to provide a positioning device of a brake lever, by which the relative position between the brake lever and a handlebar can be adjusted and fixed without other tools.

According to the aforementioned objectives, the present invention provides a brake lever, comprising a lever bracket, a finger grip bar and a positioning device. The finger grip bar is pivotally mounted on the lever bracket. The positioning device comprises a first stationary member, a second stationary member and two positioning members. The first stationary member is mounted on the lever bracket. The second stationary member corresponds to the first stationary member and can be mounted on the handlebar. The positioning members include a first positioning member and a second positioning member respectively mounted on the first stationary member and the second stationary member, wherein the positioning members can be engaged with each other to position the brake lever.

According to the aforementioned objectives, the present invention provides a positioning device of a brake lever, and the positioning device comprises a lever connection portion, an elastic element, a positioning bump and a fixing device. The lever connection portion includes an opening. The elastic element with an elastic force is disposed in the opening. The positioning bump is disposed against the elastic element, wherein the positioning bump includes a positioning end. The fixing device is set with a plurality of positioning holes. The positioning end of the positioning bump can be selectively disposed in one of the positioning holes by the elastic force to fix a relative position between the lever connection portion and the fixing device.

The advantages that can be achieved by applying preferred embodiments of the present invention includes the followings.

When a relative displacement is occurred between the brake lever and the handlebar (such as the handlebar of the bicycle or the motorcycle), i.e. the positioning end slides out of the current positioning hole, an user can rotate the brake lever relative to the handlebar until the positioning end sliding into one of the positioning holes to make the handlebar and the brake lever immediately obtain a positioning effect. In the present invention, the relative position (i.e. the original setting position) between the brake lever and the handlebar can be rapidly adjusted and fixed, so that it is very convenient in use.

### BRIEF DESCRIPTION OF THE DRAWINGS

The foregoing and other aspects, features, advantages and embodiments are more readily appreciated as the same become better understood by reference to the following detailed description, when taken in conjunction with the accompanying drawings, wherein:

FIG. 1 illustrates a three-dimensional diagram of a brake lever in accordance with a preferred embodiment of the present invention;

FIG. 2 illustrates a side view of the brake lever of FIG. 1;

FIG. 3 is a three-dimensional assembly diagram of the brake lever of FIG. 1;

FIG. 4 is a cross-sectional view of the brake lever shown in FIG. 2 along cross-sectional line 4-4; and

FIG. 5 illustrates a three-dimensional diagram of a brake lever in accordance with another preferred embodiment of the present invention.

### DETAILED DESCRIPTION OF THE PREFERRED EMBODIMENT

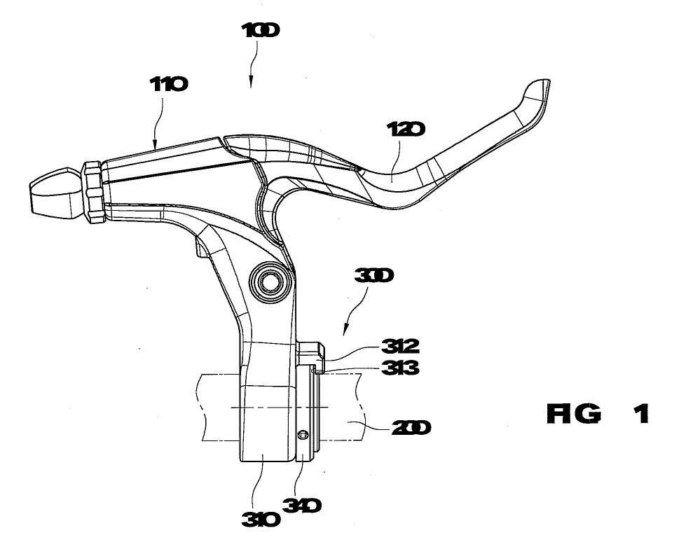

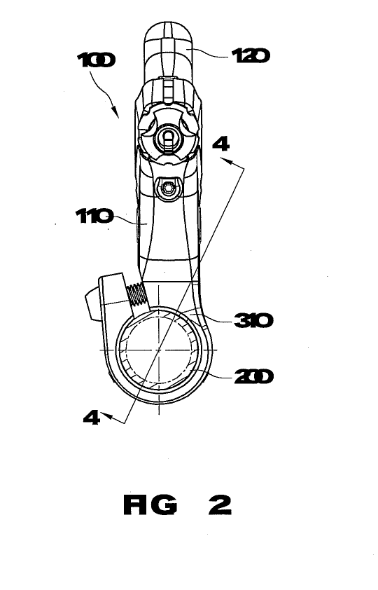

Referring to FIG. 1 and FIG. 2, a brake lever 100 in accordance with a preferred embodiment of the present invention can be mounted on a handlebar 200, such as a bicycle lever, a motorcycle lever and etc.

A positioning device 300 is set between the brake lever 100 and the handlebar 200, which provides a relative positioning function for the brake lever 100 and the handlebar 200. The brake lever 100 comprises a lever bracket 110 and a finger grip bar 120. The finger grip bar 120 is pivotally mounted on the lever bracket 110.

The positioning device 300 comprises two stationary members and two positioning members. These two stationary members are corresponding to each other, and include a first stationary member and a second stationary member, in which the first stationary member can be connected to the lever bracket 110 directly or indirectly, and the second stationary member is fixedly mounted to the handlebar 200. The two positioning members are mounted to the two stationary members respectively, and include a first positioning member and a second positioning member, wherein the two positioning members can be engaged with each other to position the lever bracket 110 relative to the handlebar 200.

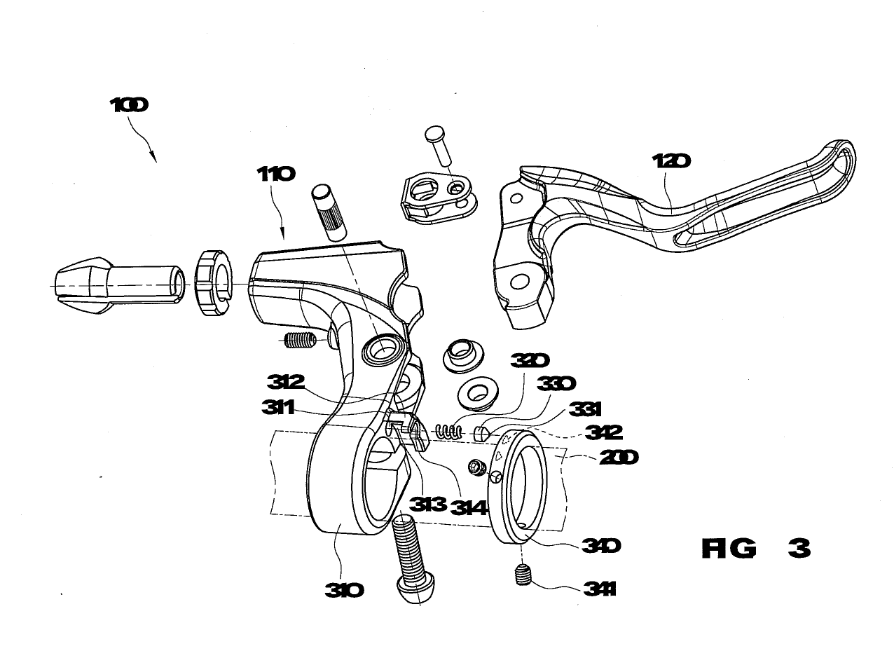

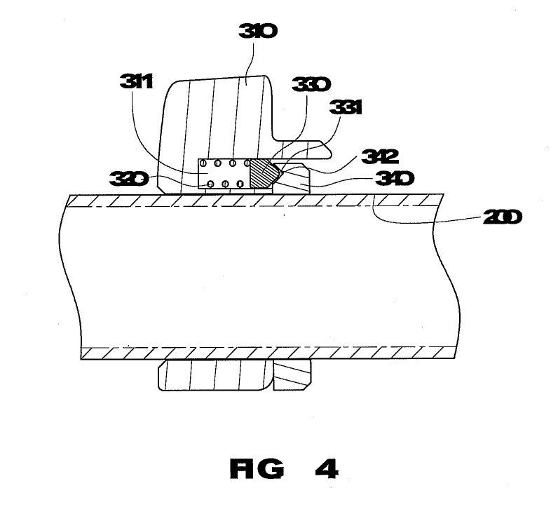

Further referring to FIG. 3 and FIG. 4, in one embodiment, the first stationary member is a lever connection portion 310 integrated with the lever bracket 110. The second stationary member is a fixing device 340, wherein the fixing device 340 may have a ring shape. The first positioning member comprises an elastic element 320 and a positioning bump 330 and is mounted on the first stationary member (i.e. the lever connection portion 310). The second positioning member includes one or more than one positioning holes 342 set in the second stationary member (i.e. the fixing device 340).

The lever connection portion 310 is integrated on the lever bracket 110 (i.e. the lever connection portion 310 and the lever bracket 110 are formed in one piece), so as to combine the brake lever 100 to the handlebar 200. The lever connection portion 310 is set with an opening 311 and an ear portion 312, wherein the ear portion 312 includes a disposed trench 313 and a through hole 314. The through hole 314 corresponds to the opening 311.

The elastic element 320 with an elastic force may be disposed in the opening 311 through the through hole 314. The elastic element 320 may be a compression spring to provide the elastic force.

The positioning bump 330 may be disposed against the elastic element 320 through the through hole 314, wherein the positioning bump 330 includes a positioning end 331. The positioning end 331 may be a tapered end.

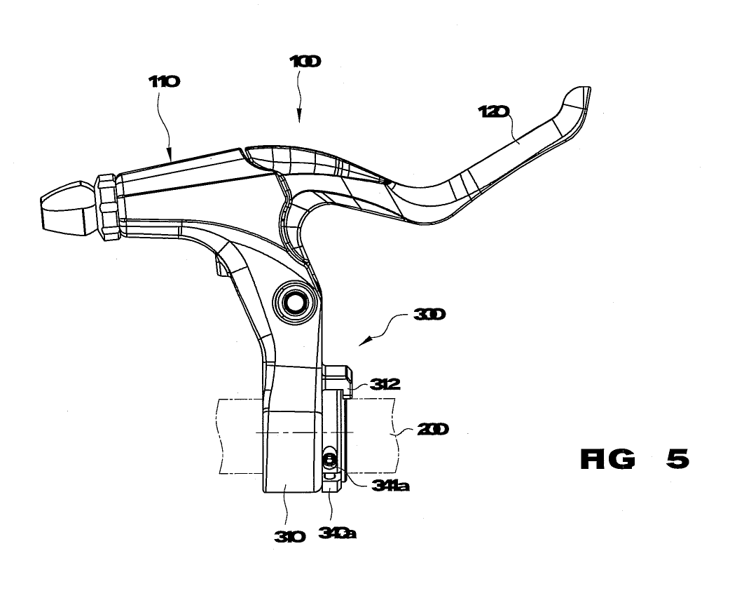

The fixing device 340 may be a fixing ring body to combine with and to fix to the handlebar 200. The fixing method may use a plurality of fixing elements 341 to screw into the fixing device 340 and to be closely against the handlebar 200. The fixing elements 341 may be countersunk screws. Each positioning hole 342 of the fixing device 340 is a tapered hole corresponding to the tapered end. Referring to FIG. 5, in another exemplary embodiment, the fixing device 340 may be replaced with a fixing device 340a, wherein the fixing device 340a is a C-shaped ring, and the C-shaped ring is fixed to the handlebar 200 by using a fixing element 341a to lock the C-shaped ring to closely hold the handlebar 200.

In addition, the fixing ring body (i.e. the fixing device 340) is partially disposed in the disposed trench 313. When the lever connection portion 310 rotates relative to the fixing device 340, the disposed trench 313 can guide the moving of the fixing device 340.

The fixing device 340 is fixed to the handlebar 200 by the fixing elements 341, so that when a relative displacement is occurred between the brake lever 100 and the handlebar 200 (i.e. the positioning end 331 slides out of the current positioning hole 342), an user can rotate the brake lever 100 relative to the handlebar 200 until the positioning end 331 sliding into one of the positioning holes 342 to make the handlebar 200 and the brake lever 100 immediately obtain a positioning effect.

The aforementioned embodiments disclose a practice type that using one single positioning bump 330 and one single fixing device 340. Without departing from the invention spirit and scope of the present invention, two positioning bumps 330 and two fixing devices 340 may be used and be respectively disposed on two opposite sides of the lever connection portion 310 to make the handlebar 200 and the brake lever 100 immediately obtain a positioning effect.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A brake lever, comprising:
a lever bracket;
a finger grip bar pivotally mounted on the lever bracket; and
a positioning device comprising:
a lever connection portion connected to the lever bracket, wherein the lever connection portion has an opening;
an elastic element with an elastic force disposed in the opening;
a positioning bump disposed against the elastic element, wherein the positioning bump includes a positioning end; and
a fixing device set with a plurality of positioning holes;
wherein the positioning end of the positioning bump can be selectively disposed in one of the positioning holes by the elastic force to fix a relative position between the lever connection portion and the fixing device.

2. The brake lever according to claim 1, wherein the fixing device is a fixing ring body.

3. The brake lever according to claim 2, wherein the lever connection portion further comprises an ear portion, and the ear portion includes a disposed trench, wherein the fixing ring body is partially disposed in the disposed trench.

4. The brake lever according to claim 3, wherein the ear portion further includes a through hole corresponding to the opening.

5. The brake lever according to claim 1, wherein the positioning end is a tapered end, and each of the positioning holes is a tapered hole corresponding to the tapered end.

6. The brake lever according to claim 1, further comprising a plurality of fixing elements, wherein each of the fixing elements is screwed into the fixing device.

7. The brake lever according to claim 6, wherein each of the fixing elements is a countersunk screw.

8. The brake lever according to claim 1, wherein the elastic element is a compression spring.

9. The brake lever according to claim 1, wherein the fixing device is a C-shaped ring.

10. The brake lever according to claim 9, further comprising a fixing element, wherein the fixing device is locked by the fixing element.
